(19) United States
(12) Patent Application Publication
(10) Pub. No.: US 2026/0062112 A1
(43) Pub. Date: Mar. 5, 2026

(54) ARRANGEMENT COMPRISING AIRCRAFT WING AND NACELLE

(71) Applicant: Heart Aerospace Incorporated, EI Segundo, CA (US)

(72) Inventor: Alain Cuenca, Göteborg (SE)

(73) Assignee: Heart Aerospace Incorporated, EI Segundo, CA (US)

(21) Appl. No.: 19/316,964

(22) Filed: Sep. 2, 2025

(30) Foreign Application Priority Data
Sep. 2, 2024 (SE) 24508772

(51) Int. Cl. B64C 3/32; B64D 31/00

(52) U.S. Cl. CPC B64C 3/32; B64D 31/00

(57) ABSTRACT

The present invention relates to an arrangement (10), comprising: an aircraft wing (12) comprising a leading edge (14), a trailing edge (16), a chord (18), a topside (20), and an underside (22); and a nacelle (24) attached to the topside, the leading edge, and the underside of the aircraft wing, wherein the nacelle has a flat sidewall (28a), a top surface (30), and a fillet edge (32a) between said flat sidewall and said top surface, wherein the flat sidewall is substantially perpendicular to the topside of the aircraft wing, wherein the fillet edge has a first local radius of curvature (r1) above the aircraft wing and a second local radius of curvature (r2) forward of the leading edge the aircraft wing, and wherein the second local radius of curvature is larger than the first local radius of curvature.

### CROSS REFERENCE TO RELATED APPLICATIONS

This application claims the benefit of Swedish Provisional Application No., SW2450877-2 filed 02 Sep. 2024 which is incorporated herein in its entirety by this reference.

### TECHNICAL FIELD

The present invention relates to an arrangement comprising an aircraft wing and a nacelle. The present invention also relates to an aircraft comprising at least one such arrangement, to a method, and to a computer program product.

### BACKGROUND

When flying at high angle of attack (flaps retracted or extended), the interaction between the wing and the nacelle of an aircraft is critical. This interaction can have a significant impact on the stall; the maximum angle of attack (AoA) reached but also the maximum associated lift coefficient.

For turboprop aircrafts, numerous publications investigate the wing/nacelle interaction for typical designs where the nacelle is located under the wing or with a limited wing/leading edge interference.

A common alternative to this layout is to design a long nacelle which covers the entire wing and then channel the flow all along the wing extrados (upper surface of the wing subjected to a suction pressure).

In both cases the horseshoe vortex created at the leading edge connecting the nacelle and the suction pic created along the extrados entail a significant interaction that can produce at high AoA an uncontrolled flow in the nacelle vicinity leading to the complete wing stall.

For a nacelle which is mainly centered on the wing (like on the Saab 340), the wing/nacelle geometric interference becomes significant and then the unexpected interaction is difficult to tackle. The horseshoe vortex created at the leading-edge intersection with the wing is interacting with the pressure distribution along the wing extrados.

A typical solution is the implementation of strakes to create vortices at specific locations in order to keep the flow attached to the wing at high AoA. However, these strakes are tricky to design and can create unwanted drag in some flight phases and represent also an additional part subject to ice accretion. Moreover, these strakes are usually not implemented on turboprop because of the swirl flow downstream the propeller.

### SUMMARY

An object of the present invention is to overcome or at least alleviate one or more drawbacks mentioned above, and to provide an improved wing and nacelle arrangement.

According to a first aspect, this object is obtained by an arrangement, comprising: an aircraft wing comprising a leading edge, a trailing edge, a chord from the leading edge to the trailing edge, a topside, and an underside; and a nacelle adapted to at least partly house a propulsion unit, wherein the nacelle is attached to the topside, the leading edge, and the underside of the aircraft wing, wherein the nacelle at has a flat sidewall, a top surface, and a fillet edge between said flat sidewall and said top surface, wherein the flat sidewall is (substantially) perpendicular to the topside of the aircraft wing, wherein the fillet edge has a first local radius of curvature above the aircraft wing and a second local radius of curvature forward of the leading edge, where the first local radius of curvature and the second local radius of curvature are considered at the intersection point between the fillet edge and the flat sidewall, and wherein the second local radius of curvature is larger than the first local radius of curvature. Moreover, the nacelle on the topside of the aircraft wing may have an extension, from said leading edge and rearwards, in the range of 52.5-70% of the length of said chord at the transverse (or lateral) position of the nacelle attachment centerline,

The present invention is at least partly based on the understanding that a nacelle having this limited extension on the topside of the aircraft wing can create a vortex at high AoA that will not reattach to the flow at the wing vicinity. Moreover, the substantially perpendicular flat sidewall can create and force the above-mentioned horseshoe vortex to take place in a well-defined planar area. Moreover, by having a larger local radius of curvature of the edge fillet forward of the leading edge, the possibilities of triggering a vortex at the (nacelle) fillet edge in front of the aircraft wing are minimized to ensure that this vortex will take place at the vicinity of the section where the first local radius of curvature is present. Overall, an improved stall angle of attack (AoA), in particular in the range of 12-14°, may be realized.

In the present disclosure, the extension of the nacelle on the topside of the aircraft wing should be construed as expressed in relation to the length of the (local) chord of the aircraft wing in clean configuration, i.e. with any flaps (and/or the like) retracted. Moreover, “said chord at the transverse position of the nacelle attachment centerline” may be virtual. Said chord may for example the average of the chord directly to the left of the nacelle and the chord directly to the right of the nacelle. Moreover, “substantially” perpendicular may be construed as 90°±5°. Moreover, “aircraft wing” may be construed as the whole wing or just a section of the wing.

Said extension is preferably in the range of 59.5-66.5% of said length of the chord. This may provide high/improved maximum lift coefficient (C_{L}) and stall AoA of the aircraft. The extension may for example be 63% of said length of the chord. Simulations made by the inventor have shown that 63% may optimize the C_{L} max while giving the best stall AoA.

The nacelle from the leading edge of the aircraft wing may have a height in the range of 16-20% of said length of the chord, preferably 16-19%, such as 18%. Simulations made by the inventor have shown that 18% may optimize the CL max while maintaining the highest stall AoA.

In another embodiment, said extension (X-Max UP) is 45.5%, and said height (Z-Max UP) is 13%. This embodiment may be advantageous in case the wing as no flap or in case the nacelle is mounted to a wing with a flap but in a position where there is no flap behind the nacelle.

The ratio between said extension (X-Max UP) and said height (Z-Max UP) is preferably 3.5, for example 63/18 or 45.5/13.

The fillet edge may have a height above the aircraft wing, which height may be in the range of 6-9% of said length of the chord. The first local radius of curvature may be in the range of 80-100% of the height of the fillet edge. This nacelle ‘sharp’ edge may act, at high angle of attack, as an ‘integrated’ vortex generator located in an optimum position (still effective for high AoA contrary to a classical strake located far ahead the wing for which the efficiency will decrease at high AoA because its vortex wake will move away from the wing). That is, at high AoA (with or without flap extended), the nacelle edge itself acts as a vortex generator, and no strakes are needed. The vortex generated at the nacelle (fillet) edge at high AoA will also combine with the horseshoe vortex created at the wing root leading edge avoiding any unwanted interaction with the wing flow. In other words, a proper nacelle top edge profile and a proper local fillet radius may be located above the wing leading edge in order to create an interaction along the (two) generated/created vortices and reduce the expansion along the wing extrados. Overall, the present nacelle's design may be defined in order to create at high AoA two vortices and to force the leading-edge horseshoe vortex not to expand along the extrados. This behaviour prevents an anticipated stall. The height of the fillet edge may for example be 9% of said length of the chord.

The flat sidewall may extend both above the aircraft wing (i.e. from the leading edge and rearwards) and forward of the leading edge of the aircraft wing.

The flat sidewall, the fillet edge, and the top surface may form a non-discontinuous (smooth) outer profile.

The top surface may be (substantially) straight in the span direction of the aircraft wing, to facilitate the setting of a 2D flow that will reduce the interaction with the wing flow.

The portion of the nacelle attached to the topside of the aircraft wing may taper in width from the leading edge towards the trailing edge of the aircraft wing. The width of said portion at its aft end may for example be (about) 95% of the width of said portion at the leading edge of the aircraft wing. Simulations made by the inventor have shown that 95% is set to get the best CL max while preserving a clean flow.

The arrangement may comprise the propulsion unit at least partly housed in the nacelle. The propulsion unit may comprise at least one of: an electric motor, a fuel-based engine, and a propeller. The propulsion unit may for example comprise an electric motor and propeller, or a fuel-based engine and a propeller, or an electric motor and a fuel-based engine and a propeller (parallel hybrid). Accordingly, the propulsion unit may (generally) comprise a propeller.

The nacelle may be shaped and attached to the aircraft wing as illustrated in in one or more of FIGS. 1a-1e or FIGS. 6a-6d of the drawings.

The arrangement may further comprise a second nacelle according to any embodiment of the nacelle claimed and/or described hereinabove.

According to a second aspect of the present invention, there is provided an aircraft comprising at least one arrangement according to the first aspect. Typically the aircraft will comprise two such arrangements, namely one left (aircraft) wing and one right (aircraft) wing. The aircraft may for example be one or more of: an airplane, an electric propulsion aircraft, a hybrid electric propulsion aircraft, a fixed-wing aircraft, a conventional take-off and landing (CTOL) aircraft, a monoplane, and adapted to be flown by a pilot on board the aircraft. The aircraft may for example comprise one or more of: a fuselage, (the) wings attached to the top side of the fuselage, an empennage, a cockpit, a passenger cabin, flight control surfaces (such as ailerons, elevators, a rudder, flaps, air brakes, etc.), and (wheeled and/or retractable) landing gear.

According to a third aspect of the present invention, there is provided a method, comprising: providing a nacelle for attachment to a predetermined aircraft wing, wherein the aircraft wing comprises a leading edge, a trailing edge, a chord from the leading edge to the trailing edge, a topside, and an underside, wherein the nacelle is adapted to be attached to the topside, the leading edge, and the underside of the aircraft wing, and wherein the nacelle has a flat sidewall, a top surface, and a fillet edge between said flat sidewall and said top surface, wherein the flat sidewall is substantially perpendicular to the topside of the aircraft wing when the nacelle is attached to the aircraft wing, wherein the fillet edge has a first (local) radius of curvature above the aircraft wing and a second (local) radius of curvature forward of the leading edge, where the first local radius of curvature and the second local radius of curvature are considered at the intersection point between the fillet edge and the flat sidewall, and wherein the second local radius of curvature is larger than the first local radius of curvature. Moreover, the nacelle (when attached to the aircraft wing) on the topside of the aircraft wing may have an extension, from said leading edge and rearwards, e.g. in the range of 52.5-70% of the length of said chord at the lateral position of the nacelle attachment centerline. This aspect may exhibit the same or similar features and/or technical effects as the first or second aspects, and vice versa. The nacelle may be adapted to at least partly house a propulsion unit. Alternatively, the nacelle may be adapted to house fuel, equipment, etc. Moreover, the nacelle could be retrofitted to the aircraft wing optionally comprising an existing propulsion unit.

According to a fourth aspect of the present invention, there is provided a computer program product comprising computer program code to perform, when executed on a computer, the steps of: receiving data related to an aircraft wing comprising a leading edge, a trailing edge, a chord from the leading edge to the trailing edge, a topside, and an underside; determining the shape and dimensions of a nacelle to be attached to the topside, the leading edge, and the underside of the aircraft wing at least partly based on the received data, such that-the nacelle has a flat sidewall, a top surface, and a fillet edge between said flat sidewall and said top surface, the flat sidewall is substantially perpendicular to the topside of the aircraft wing, the fillet edge has a first local radius of curvature above the aircraft wing and a second local radius of curvature forward of the leading edge, where the first local radius of curvature and the second local radius of curvature are considered at the intersection point between the fillet edge and the flat sidewall, and the second local radius of curvature is larger than the first local radius of curvature; and outputting the determined shape and dimensions of the nacelle in at least one data record. This aspect may exhibit the same or similar features and/or technical effects as any one of the first to third aspects, and vice versa. For example, the shape and dimensions of the nacelle to be attached may further be determined such that the nacelle on the topside of the aircraft wing has an extension, from said leading edge and rearwards, e.g. in the range of 52.5-70% of the length of said chord at the transverse position of the nacelle attachment centerline.

According to a fifth aspect, there is provided a computer-readable storage medium comprising the computer program product according to the fourth aspect. The computer-readable storage medium may be a non-transitory computer-readable storage medium.

According to a sixth aspect, there is provided an electrical signal embodied on a carrier wave and propagated on an electrical medium, the electrical signal comprising the computer program product according to the fourth aspect.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1a is a perspective view of an arrangement according to one or more embodiments of the present invention.

FIG. 1b is a top view of the arrangement in FIG. 1a.

FIG. 1c is a side view of the arrangement in FIG. 1a.

FIG. 1d is a front view of the arrangement in FIG. 1a.

FIG. 1e is a perspective view of the arrangement in FIGS. 1a-d with extended flap.

FIG. 2a shows charts related to parameter X-Max UP.

FIG. 2b shows charts related to height Z-Max UP.

FIG. 2c shows charts related to height Fillet 1 UP.

FIG. 2d shows charts related to width W-Aft.

FIG. 3a is a schematic top view of an aircraft according to an aspect of the present invention.

FIG. 3b is a schematic perspective view of an aircraft in FIG. 1a.

FIG. 4 is a flowchart according to an aspect of the present invention.

FIG. 5 schematically illustrates a computer program product according to an aspect of the present invention.

FIG. 6a is a perspective view of an arrangement according to another embodiment of the present invention.

FIG. 6b is a top view of the arrangement in FIG. 6a.

FIG. 6c is a side view of the arrangement in FIG. 6a.

FIG. 6d is a front view of the arrangement in FIG. 6a.

### DETAILED DESCRIPTION

Aspects of the present disclosure will be described more fully hereinafter with reference to the accompanying drawings. The apparatus and/or method disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. As used herein, the singular forms “a”, “an” and “the” are intended to include the plural forms as well, unless the context clearly indicates otherwise.

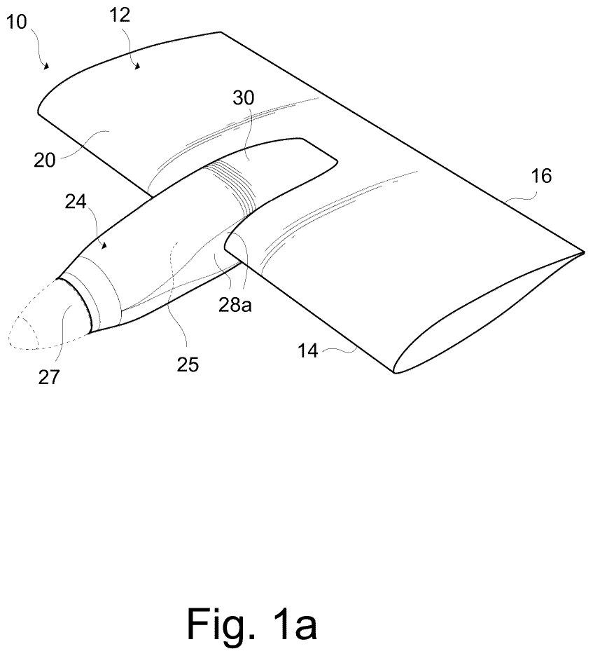

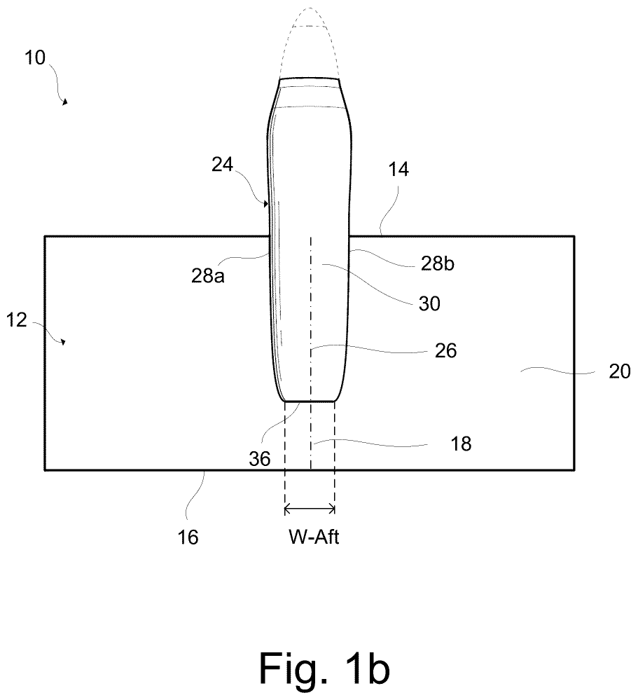

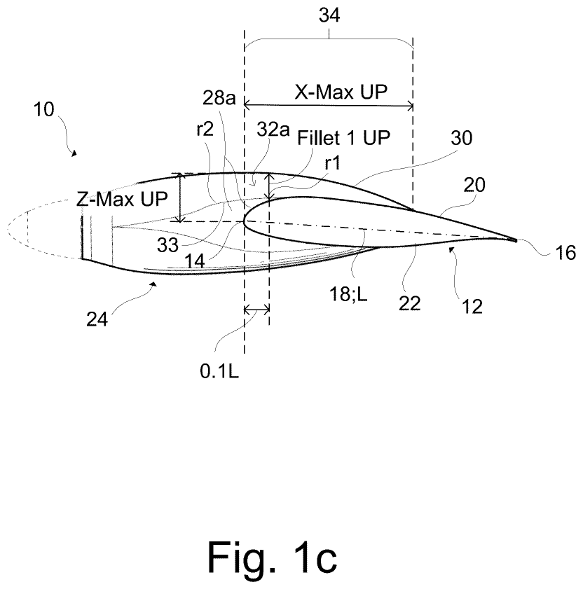

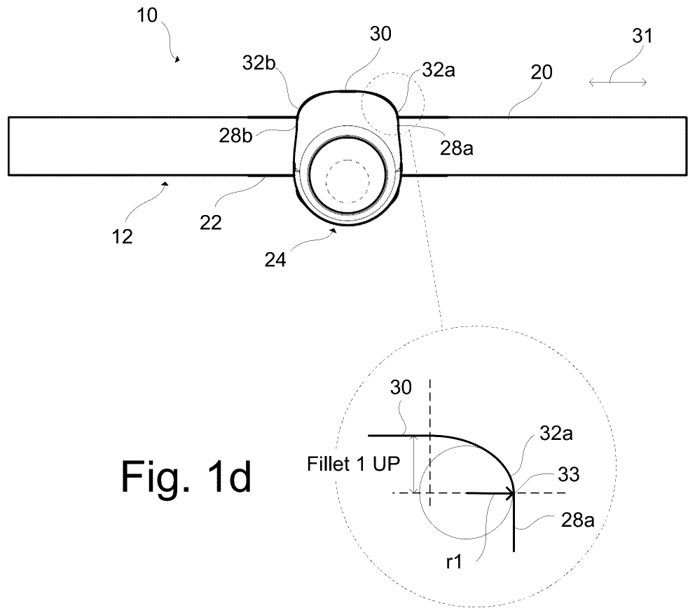

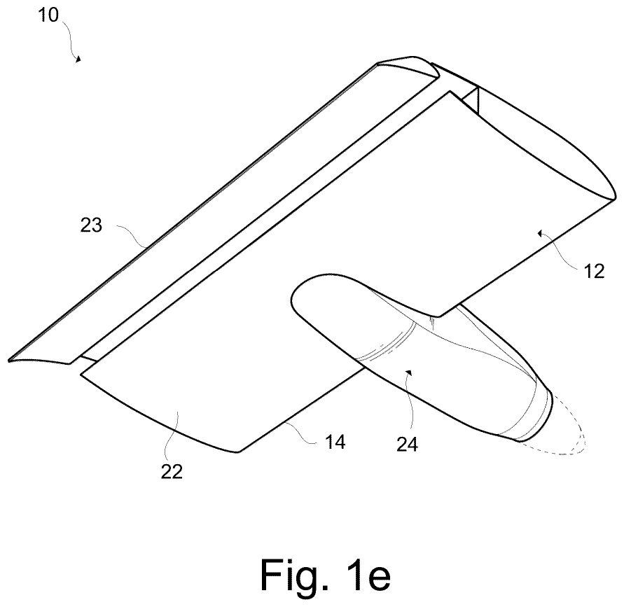

FIGS. 1a-e show an aircraft wing and nacelle arrangement 10 according to one or more embodiments of the present invention.

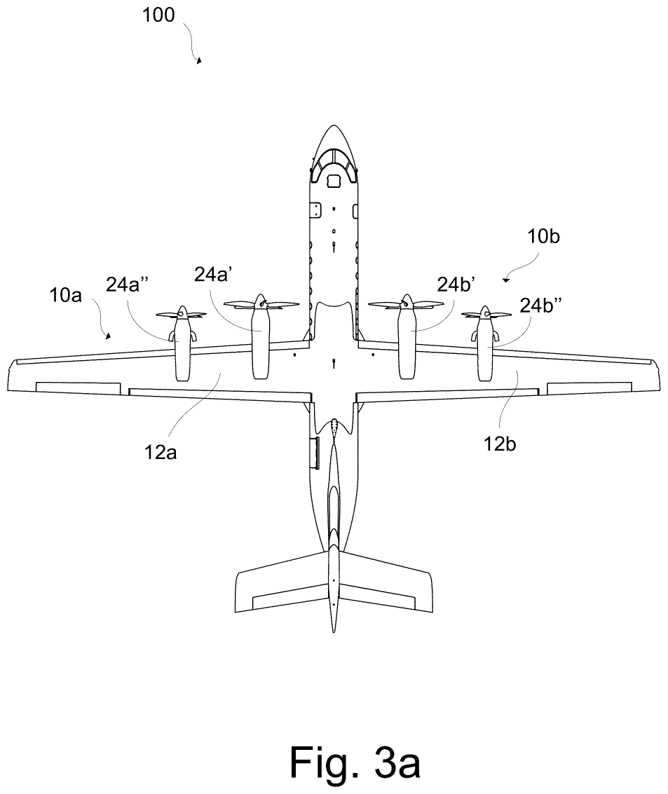

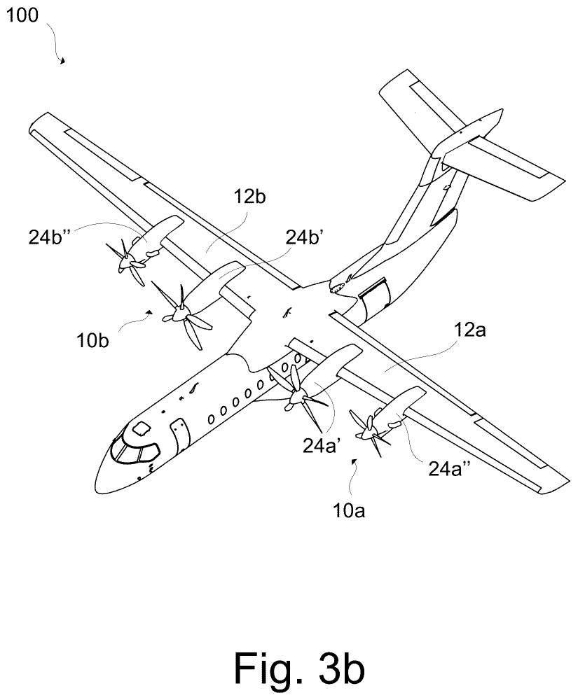

The arrangement 10 comprises an aircraft wing 12. The aircraft wing 12 will typically be a main wing of an aircraft, such as aircraft 100 (see FIGS. 3a-b). The aircraft wing 12 may for example be a constant chord wing or tapered (wing narrows towards the tip). The aircraft wing 12 may for example be straight (extends at right angles to the line of flight) or swept back. The aircraft wing 12 may or may not be dihedral. The aircraft wing 12 may be a high wing.

The aircraft wing 12 comprises a leading edge 14, a trailing edge 16, a chord 18 from the leading edge 14 to the trailing edge 16, a topside 20, and an underside 22. At the trailing edge 16, the aircraft wing 12 may comprise at least one flap 23, see FIG. 1e. The (maximum) thickness of the aircraft wing 12 may be in the range of 12-21% of the length L of the chord 18, such as 17%.

The arrangement 10 further comprises a nacelle 24. A nacelle, such as nacelle 24, may generally be defined as a streamlined enclosure on an aircraft (Merriam-Webster). Here, the nacelle 24 may be adapted to at least partly house or accommodate a propulsion unit 25. The propulsion unit 25 may for example comprise an electric motor inside the nacelle 24, which electric motor is coupled to a propeller fore of the nacelle 24. Alternatively, the propulsion unit 25 could comprise a fuel-based engine inside the nacelle 24, which fuel-based engine is coupled to a propeller fore of the nacelle 24 (turboprop). In yet another alternative, the propulsion unit 25 comprises an electric motor and a fuel-based engine inside the nacelle 24 and a propeller outside the nacelle 24 (parallel hybrid). The nacelle 24 may comprises a front opening 27 for a propeller shaft coupled to any one of the above-mentioned propellers.

The nacelle 24 may be attached to the topside 20, the leading edge 14, and the underside 22 of the aircraft wing 10. As such, the nacelle 24 may be centrally positioned on the wing 10. In this way, the thrust line gets close to the wing box center leading to a reduced torsion, compared to conventional designs where the nacelle is located under the wing. The angle of incidence between the aircraft wing 12 and the nacelle 24 may for example be in the range of 0-4.5°, such as 4.5°. The nacelle 24 may be mounted in a position where a flap (such as flap 23) is located behind the nacelle 24, as seen for example in FIG. 1e.

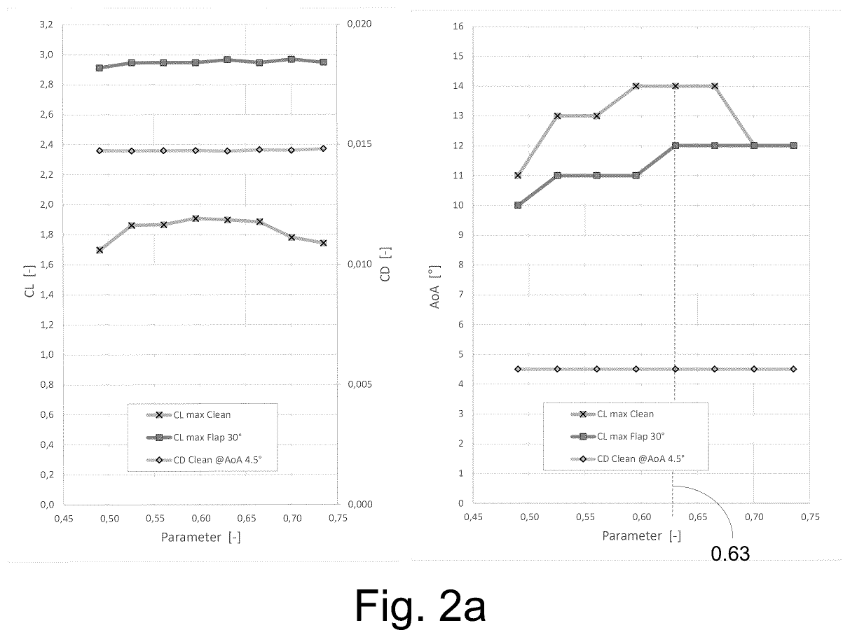

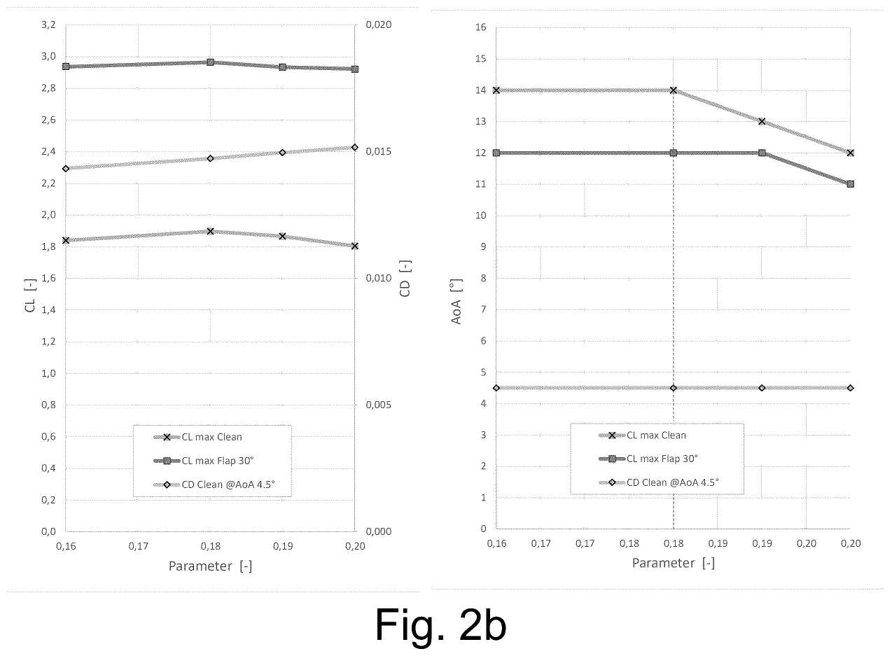

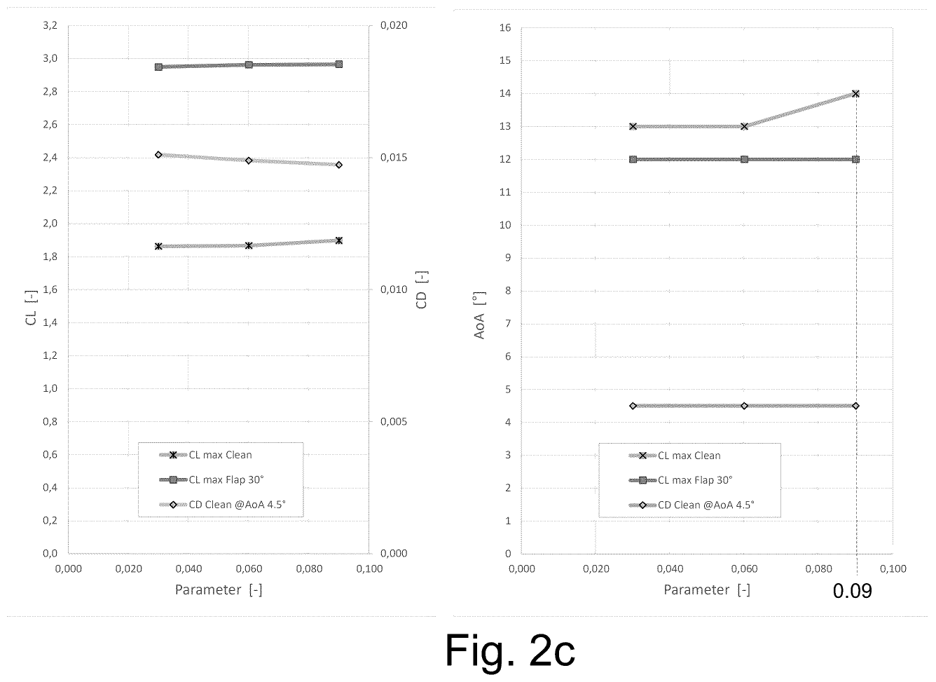

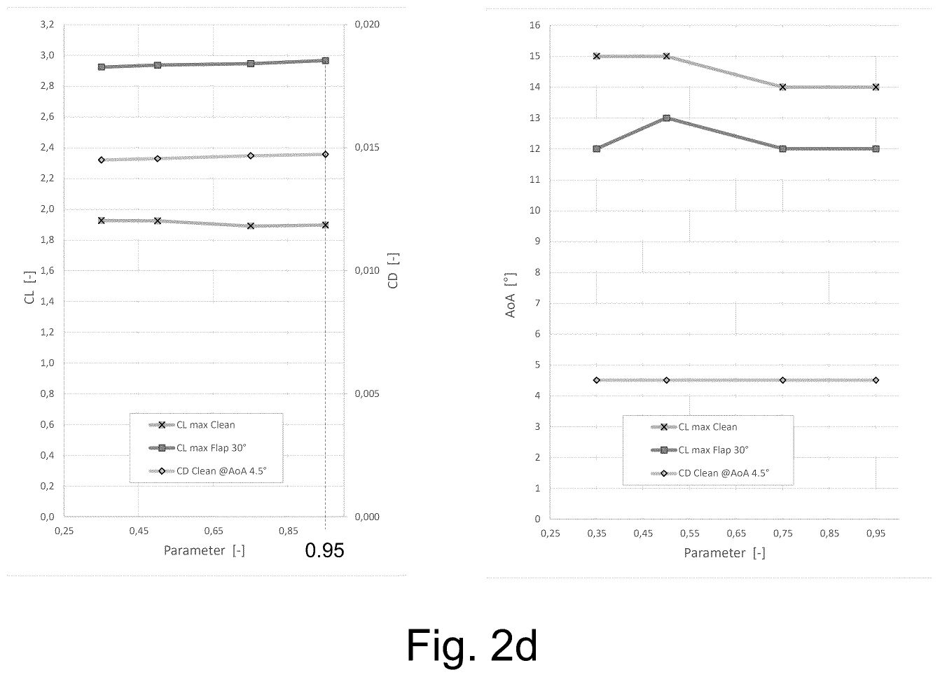

The nacelle 24 may have a limited extension X-Max UP on the topside 20 of the aircraft wing 12, as will be discussed in more detail hereinbelow with further reference to FIG. 2a. X-Max UP may be defined as perpendicular to the plane of rotation of the aforementioned propeller. On the underside 22 of the aircraft wing 12, the nacelle 24 may extend, starting from the leading edge 14, over less of the chord 18 of the aircraft wing 12 than on the topside 20 of the aircraft wing 12. In any case, the nacelle 24 on the underside 22 should not extend onto the flap 23.

Moving on, the nacelle 24 has a flat sidewall 28a, a top surface 30, and a fillet edge (i.e. a rounded edge) 32a connecting the flat sidewall 28a and the top surface 30. The nacelle 24 with typically also have a second flat sidewall 28b on the opposite side, and a second fillet edge 32b connecting that flat sidewall 28b and the top surface 30. The nacelle 24 also has a height Z-Max UP from the leading edge 14 of the aircraft wing 12, as will be discussed in more detail hereinbelow with further reference to FIG. 2b. Z-Max UP may be defined as parallel to the plane of rotation of the aforementioned propeller.

The flat sidewall 28a (and sidewall 28b) may be substantially perpendicular (e.g. 90°±5°) to the topside 20 of the aircraft wing 12, as seen for example in FIG. 1d. As such, the flat sidewall 28a (and sidewall 28b) may be vertically arranged (at zero roll). Moreover, the flat sidewall 28a (and sidewall 28b) may extend both above the aircraft wing 12 and forward of the leading edge 14 of the aircraft wing 12. Above the aircraft wing 12, the flat sidewall 28a (and sidewall 28b) may extend from the leading edge 14 and rearwards, for example over 15-25% of the length L of the chord 18 of the aircraft wing 12.

The top surface 30 may be substantially straight in the (wing) span direction 31 of the aircraft wing 12, as seen for example in FIG. 1d.

The fillet edge 32a (and fillet edge 32b) may have a height Fillet 1 UP and a first local radius of curvature r1 above the aircraft wing 12. Specifically, Fillet 1 UP may be the height (of the filled edge) from where the flat sidewall 28a (28b) meets the fillet edge 32a (32b) to where the fillet edge 32a (32b) meets the top surface 30 (as seen from the side). The fillet edge 32a (and fillet edge 32b) also has a second local radius of curvature r2 forward of the leading edge 14 the aircraft wing 12, wherein the second local radius of curvature r2 should be larger than the first local radius of curvature r1. Above the aircraft wing 12, the first local radius of curvature r1 may be present from the leading edge 14 and rearwards, for example over 15-25% of the length L of the chord 18 of the aircraft wing 12. Here the first local radius of curvature r1 may be constant or decrease from the leading edge 14 and rearwards. Specifically, the height Fillet 1 UP may be in the range of 6-9% of the length L of the chord 18 of the aircraft wing 12, as will be discussed in more detail hereinbelow with further reference to FIG. 2c. Fillet 1 UP may be defined as parallel to the plane of rotation of the aforementioned propeller.

The first local radius of curvature ri may depend on the height Fillet 1 UP. Specifically, the first local radius of curvature ri should be in the range of 80-100% of the height Fillet 1 UP of the fillet edge 32a (0.80*Fillet 1 UP≤r1≤1*Fillet 1 UP). Moreover, as seen in the enlargement in FIG. 1d, which enlargement represents a section at 0.1 L (see FIG. 1c), the first local radius of curvature ri may be considered at the intersection point 33 between the fillet edge 32a and the flat sidewall 28a. This means that from that intersection point 33, the fillet edge 32a should for at least some distance follow a circle (e.g. as shown in FIG. 1d) which is attached to that point and (preferably) has a radius in that range of 80-100% of the height Fillet 1 UP. Likewise, the second local radius of curvature r2 may be considered at the intersection point 33 between the fillet edge 32a and the flat sidewall 28a, albeit r2 is greater than ri and forward of the leading edge 14. Moreover, it can be seen that the curvature of the fillet edge 32a may have an increased local radius of curvature (i.e. less curving) closer to the top surface 30. For example, the local radius of curvature of a circle attached to the fillet edge 32a at 45° may be 81.4% of Fillet 1 UP, whereas the local radius of curvature of a circle attached to the fillet edge 32a at 60° may be 83.9% of Fillet 1 UP. Moreover, it can be seen that the flat sidewall 28a, the fillet edge 32a, and the top surface 30 may form 28a non-discontinuous (smooth) outer profile. The features mentioned in this paragraph will typically also apply for the second sidewall 28b and fillet edge 32b.

Furthermore, as exemplified in FIG. 1b, the portion 34 of the nacelle 24 attached to the topside 20 of the aircraft wing 12 may taper in width from the leading edge 14 towards the trailing edge 16 of the aircraft wing 12. The width W-Aft of that portion 34 at its aft end 36 may for example be 95% of the width at the leading edge 14 of the aircraft wing 12, as will be discussed in more detail hereinbelow with further reference to FIG. 2d.

Returning to X-Max UP, the extension X-Max UP of the nacelle 24 on the topside 20 of the aircraft wing 12, from the leading edge 14 and rearwards, should be in the range of 52.5-70% of the length L of the chord 18 at the transverse position of the nacelle attachment centerline 26. That is, 0.525 L≤X-Max UP≤0.70 L. The nacelle attachment centerline 26 may be construed as a line in the center of the nacelle 24 as attached to the aircraft wing 12, as shown in FIG. 1b. And the “transverse position” (or lateral position) may be the line's position in the left/right direction in FIG. 1b, as opposed to a vertical position. As seen in FIG. 2a right, where X-Max UP is on the horizontal axis and angle of attack (AoA) is on the vertical axis, this range may result in a stall AoA of 12-14° in clean configuration of the aircraft wing 12 and 11-12° with the at least one flap 23 extended to 30°. Preferably, 0.595 L≤X-Max UP≤0.665 L, which results in a stall AoA of 14° in clean configuration and 11-12° with the at least one flap 23 extended to 30°. Most preferably, X-Max UP=0.63 L. Simulations made by the inventor have shown that 63% may optimize the CL max while giving the best stall AoA, namely 14° in clean configuration and 12° with the at least one flap 23 extended to 30°. Note that in FIG. 2a, Z-Max-UP is 0.18, Fillet 1 UP is 0.09, and W-Aft is 0.95. When the results of the simulations of various designs were plotted on a scatter diagram with flap 30° on the vertical axis and clean configuration on the horizontal axis, the design with X-Max UP=0.63 L, Z-Max-UP=0.18, Fillet 1 UP=0.09, and W-Aft=0.95 was on the pareto front, meaning that any improvement of one objective (clean configuration) would be achieved by degradation of the others objectives (flap 30°).

Moreover, the height Z-Max UP of the nacelle 24 from the leading edge 14 of the aircraft wing 12 may be in the range of 16-20% of the length L of the chord 18. That is, 0.16 L≤X-Max UP≤0.20 L. As seen in FIG. 2b right, where Z-Max UP is on the horizontal axis and AoA is on the vertical axis, this range may result in a stall AoA of 12-14° in clean configuration of the aircraft wing 12 and 11-12° with the at least one flap 23 extended to 30°. Preferably, 0.16 L≤X-Max UP≤0.19 L, which results in a stall AoA of 13-14° in clean configuration and 12° with the at least one flap 23 extended to 30°. Most preferably, the height Z-Max UP of the nacelle 24 from the leading edge 14 of the aircraft wing 12 is 18% of the length L of the chord 18. Simulations made by the inventor have shown that 18% may optimize the CL max while maintaining the highest stall AoA, namely 14° in clean configuration and 12° with the at least one flap 23 extended to 30°. Note that in FIG. 2b, X-Max-UP is 0.63, Fillet 1 UP is 0.09, and W-Aft is 0.95.

Moreover, as already mentioned, the height Fillet 1 UP of the filled edge 32a (and/or 32b) above the aircraft wing 12 may be in the range of 6-9% of the length L of the chord 18 of the aircraft wing 12. That is, 0.06 L≤Fillet 1 UP≤0.09 L. As seen in FIG. 2c right, where Fillet 1 UP is on the horizontal axis and AoA is on the vertical axis, this range may result in a stall AoA of 13-14° in clean configuration of the aircraft wing 12 and 12° with the at least one flap 23 extended to 30°. Preferably, Fillet 1 UP is 9% the length L of the chord 18 of the aircraft wing 12, which may result in a stall AoA of 14° in clean configuration of the aircraft wing 12 and 12° with the at least one flap 23 extended to 30°. Note that in FIG. 2c, X-Max-UP is 0.63, Z-Max-UP is 0.18, and W-Aft is 0.95. Moreover, Fillet 1 UP is defined at 10% of the chord 18 (0.1 L) starting from the leading edge 14, wherein 0.1 L is perpendicular to the plane of rotation of the aforementioned propeller, see FIG. 1c.

Moreover, as already mentioned, the width W-Aft of the portion 34 of the nacelle 24 attached to the topside 20 of the aircraft wing 12 may be 95% of the width at the leading edge 14 of the aircraft wing 12. Simulations made by the inventor have shown that 95% is set to get the best C_{L} max while preserving a clean flow, which can be seen in FIG. 2d. In FIG. 2d left, W-Aft is on the horizontal axis, C_{L} is on the left vertical axis, and C_{D} (drag coefficient) is on the right vertical axis. In FIG. 2d right, W-Aft is on the horizontal axis and AoA is on the vertical axis. W-Aft=0.95 here results in a stall AoA of 14° in clean configuration of the aircraft wing 12 and 12° with the at least one flap 23 extended to 30°. Note that in FIG. 2c, X-Max-UP is 0.63, Z-Max-UP is 0.18, and Fillet 1 UP is 0.09.

In accordance with the present invention, the nacelle 24 may be defined in order to create at high AoA two vortices and to force the leading edge horseshoe vortex not to expand along the extrados, which behaviour prevents an anticipated stall. Specifically, the substantially perpendicular flat sidewall 28a (and 28b) can create and force the horseshoe vortex to take place in a well-defined planar area. Moreover, a proper nacelle top edge profile (r2>r1) and a proper local fillet radius (r1) may be located above the wing leading edge 14 in order to create an interaction along these two vortices and reduce the expansion along the wing extrados. Also, X-Max UP is short enough (for example 0.63 L) to create a vortex at high AoA that will not reattach to the flow at the wing vicinity. Overall, an improved stall angle of attack, in particular in the range of 12-14°, may be realized. Also, extra drag may be limited.

Turning to FIGS. 3a-b, aircraft 100 may comprise two arrangements 10, here left arrangement 10a with left aircraft wing 12a and right arrangement 10b with right aircraft wing 12b. As illustrated, the wings 12a-b may for example be tapered, straight, high wings.

Moreover, each arrangement 10a-b may comprise two nacelles of any type disclosed hereinabove. Specifically, the left arrangement 10a may comprise an inner nacelle 24a′ housing an electric motor coupled to a first propeller and an outer nacelle 24a″ housing a fuel-based engine (turboprop) coupled to a second propeller. Likewise, the right arrangement 10b may comprise an inner nacelle 24b′ housing an electric motor coupled to a third propeller and an outer nacelle 24b″ housing a fuel-based engine (turboprop) coupled to a fourth propeller. The aircraft 100 may further comprise one or more batteries adapted to power the electric motor(s). The fuel-based engine(s) preferably use(s) sustainable aviation fuel (SAF).

It should be noted that other configurations are possible, for example each wing having only one nacelle 24 each housing an electric motor coupled to a propeller, each wing having two nacelles 24 each housing an electric motor coupled to a propeller, etc.

The aircraft 100 may further comprise a fuselage, an empennage, a cockpit, a passenger cabin, flight control surfaces (such as ailerons, elevators, a rudder, flaps, air brakes, etc.), and (wheeled and/or retractable) landing gear, etc. The aircraft 100 may for example be hybrid electric propulsion CTOL airplane of fixed wing type.

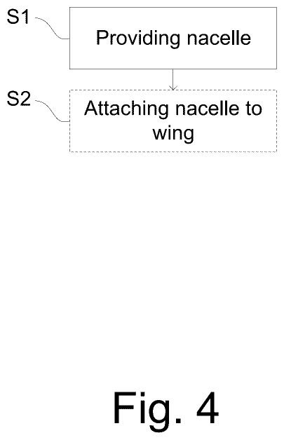

FIG. 4 is a flowchart of a method according to an aspect of the present invention. The method comprises providing (step S1) nacelle 24 for attachment to a predetermined aircraft wing 12, wherein the aircraft wing comprises leading edge 14, trailing edge 16, chord 18 from the leading edge 14 to the trailing edge 16, topside 20, and underside 22, wherein the nacelle is adapted to be attached to the topside 20, the leading edge 14, and the underside 22 of the aircraft wing, wherein the nacelle 24—when attached to the aircraft wing 12—on the topside 20 of the aircraft wing 12 has an extension X-Max UP, from the leading edge 14 and rearwards, for example in the range of 52.5-70% of the length L of the chord 18 at the lateral position of the nacelle attachment centerline 26, and wherein the nacelle has flat sidewall 28a, top surface 30, and fillet edge 32a between the flat sidewall 28a and the top surface 30, wherein the flat sidewall 28a is substantially perpendicular to the topside 20 of the aircraft wing 12 when the nacelle 24 is attached to the aircraft wing 12, wherein the fillet edge 32a has first local radius of curvature ri above the aircraft wing 12 and second local radius of curvature r2 forward of the leading edge 14, and wherein the second local radius of curvature r2 is larger than the first local radius of curvature r1. The method may further comprise attaching (optional step S2) the provided nacelle 24 to the aircraft wing 12.

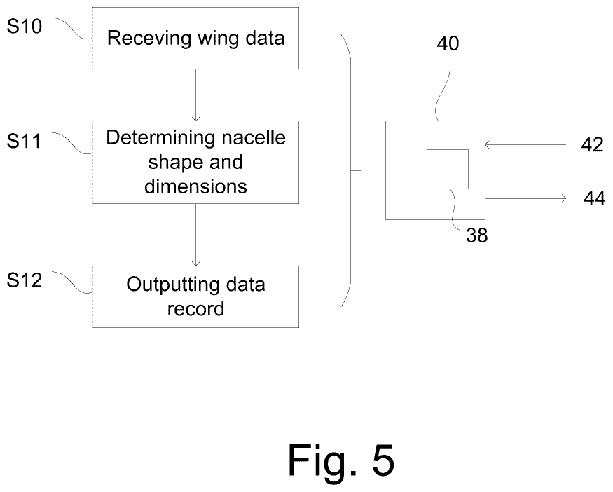

FIG. 5 schematically illustrates a computer program product 38 according to an aspect of the present invention. The computer program product 38 comprises computer program code to perform, when executed on a computer 40, the steps of: receiving (S10) data 42 related to an aircraft wing 12 comprising leading edge 14, trailing edge 16, chord 18 from the leading edge 14 to the trailing edge 16, topside 20, and underside 22; determining (S11) the shape and dimensions of nacelle 24 to be attached to the topside 20, the leading edge 14, and the underside 22 of the aircraft wing 12 at least partly based on the received data, such that the nacelle 24 on the topside 20 of the aircraft wing 12 has an extension X-Max UP, from the leading edge 14 and rearwards, for example in the range of 52.5-70% of the length L of the chord 18 at the transverse position of the nacelle attachment centerline 26, the nacelle 24 has flat sidewall 28a, top surface 30, and fillet edge 32a between the flat sidewall 28a and the top surface 30, the flat sidewall 28a is substantially perpendicular to the topside 20 of the aircraft wing 12, the fillet edge 32a has a first local radius of curvature ri above the aircraft wing 12 and a second local radius of curvature r2 forward of the leading edge 14, and the second local radius of curvature r2 is larger than the first local radius of curvature r1; and outputting (S12) the determined shape and dimensions of the nacelle in at least one data record.

The data 42 received in S10 may for example be a CAD file of the aircraft wing 12 and/or one or more photos of the aircraft wing 12. Step S11 may be performed using a processor of the computer 40. The least one data record output in S12 may for example be a CAD file.

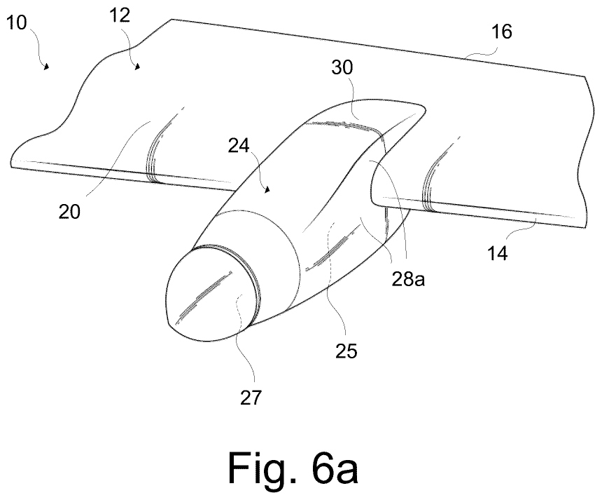

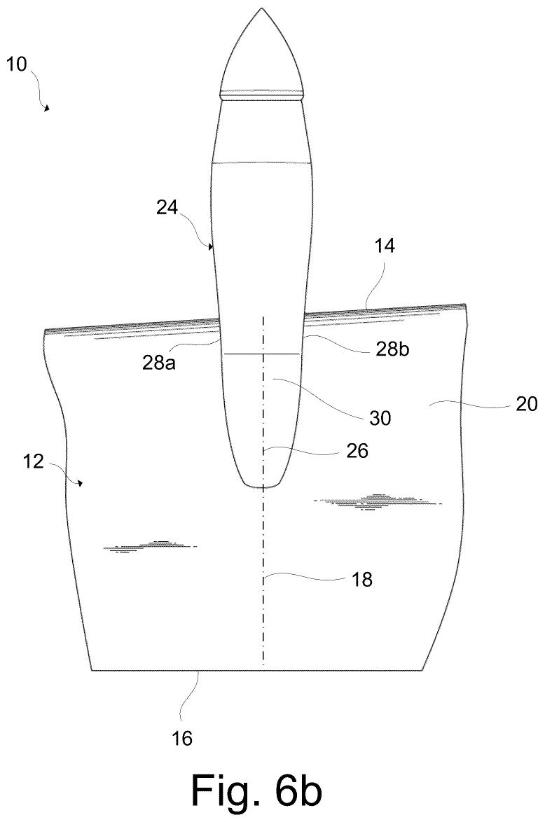

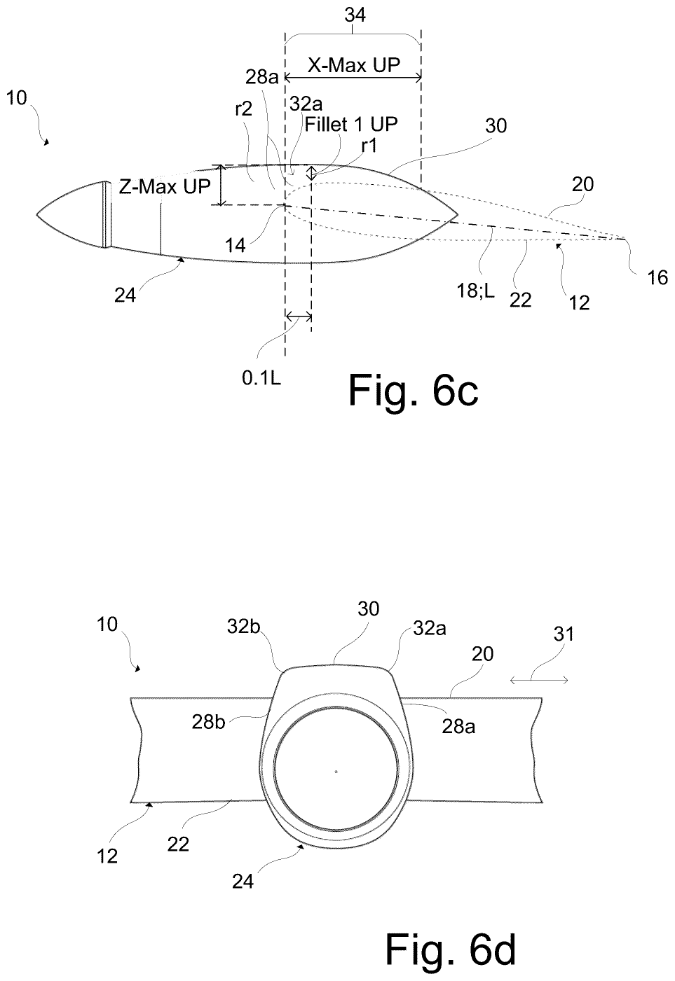

FIGS. 6a-d illustrate an arrangement 10 according to another embodiment of the present invention. This embodiment may be useful when there is no flap on the aircraft wing 12. This embodiment may be similar to the previously discussed embodiment(s), with some exceptions:
The angle of incidence between the aircraft wing 12 and the nacelle 24 may be 1.5°.
The aircraft wing 12 may have no flap(s). Alternatively, the aircraft wing 12 may have at least one flap like flap 23, but the nacelle 24 is mounted in a position where there is no flap behind the nacelle 24.
The extension X-Max UP is 45.5% and the height Z-Max UP is 13%. However, the ratio between X-Max UP and Z-Max UP is still 3.5.
The width of the portion 34 of the nacelle 24 attached to the topside 20 of the aircraft wing 12 may generally be reduced. However, the portion immediately behind the leading edge 14 still has a constant width.
The height Fillet 1 UP of the fillet edge 32a-b above the aircraft wing 12 may be approximately 3% of the length L of the chord 18 of the aircraft wing 12, such as 3.1% of the length L of the chord 18 of the aircraft wing 12. The first local radius of curvature ri could here be 86% of the height Fillet 1 UP. This fillet edge 32a-b may be sharper than the fillet edge 32a-b of the previous embodiment(s).
The stall angle of attack AoA is 11°.

It should be appreciated that a flowchart comprises some operations which are illustrated with a solid border and some operations which are illustrated with a dashed border. The operations which are comprised in a solid border are operations which are comprised in the broadest example embodiment. The operations which are comprised in a dashed border are example embodiments which may be comprised in, or a part of, or are further operations which may be taken in addition to the operations of the broadest example embodiments. It should be appreciated that these operations need not be performed in order. Furthermore, it should be appreciated that not all of the operations need to be performed. The example operations may be performed in any order and in any combination.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. An arrangement, comprising:
an aircraft wing comprising a leading edge, a trailing edge, a chord from the leading edge to the trailing edge, a topside, and an underside; and
a nacelle adapted to at least partly house a propulsion unit, wherein the nacelle is attached to the topside, the leading edge, and the underside of the aircraft wing,
wherein the nacelle has a flat sidewall, a top surface, and a fillet edge between said flat sidewall and said top surface,
wherein the flat sidewall is substantially perpendicular to the topside of the aircraft wing,
wherein the fillet edge has a first local radius of curvature (r1) above the aircraft wing and a second local radius of curvature (r2) forward of the leading edge the aircraft wing, where the first local radius of curvature and the second local radius of curvature are considered at the intersection point between the fillet edge and the flat sidewall, and
wherein the second local radius of curvature is larger than the first local radius of curvature.

2. An arrangement according to claim 1, wherein the nacelle on the topside of the aircraft wing has an extension (X-Max UP), from said leading edge and rearwards, in the range of 52.5-70% of the length (L) of said chord at the transverse position of the nacelle attachment centerline, and wherein preferably said extension (X-Max UP) is in the range of 59.5-66.5% of said length of the chord.

3. An arrangement according to claim 2, wherein the nacelle from the leading edge of the aircraft wing has a height (Z-Max UP) in the range of 16-20% of said length of the chord.

4. An arrangement according to claim 2, wherein the nacelle on the topside of the aircraft wing has an extension (X-Max UP), from said leading edge and rearwards, relative to the length (L) of said chord at the transverse position of the nacelle attachment centerline (26), wherein the nacelle from the leading edge of the aircraft wing has a height (Z-Max UP) relative to said length of the chord, and wherein the ratio between said extension and said height is 3.5.

5. An arrangement according to claim 1, wherein the fillet edge has a height (Fillet 1 UP) above the aircraft wing, which height (Fillet 1 UP) is in the range of 6-9% of said length of the chord, and wherein the first local radius of curvature is in the range of 80-100% of said height of the fillet edge.

6. An arrangement according to claim 1, wherein the flat sidewall, the fillet edge, and the top surface form a non-discontinuous outer profile.

7. An arrangement according to claim 1, wherein the top surface is substantially straight in the span direction of the aircraft wing.

8. An arrangement according to claim 1, wherein the portion of the nacelle attached to the topside of the aircraft wing tapers in width from the leading edge towards the trailing edge of the aircraft wing.

9. An arrangement according to claim 8, wherein the width (W-Aft) of said portion at its aft end is about 95% of the width of said portion (34) at the leading edge of the aircraft wing.

10. An arrangement according to claim 1, wherein the maximum thickness of the aircraft wing is in the range of 12-21% of said length of the chord.

11. An arrangement according claim 1, comprising the propulsion unit at least partly housed in the nacelle.

12. An arrangement according claim 1, wherein the propulsion unit comprises at least one of: an electric motor, a fuel-based engine, and a propeller.

13. An aircraft comprising at least one arrangement according to the arrangement of claim 1.

14. A method, comprising:
providing a nacelle for attachment to a predetermined aircraft wing, wherein the aircraft wing comprises a leading edge, a trailing edge, a chord from the leading edge to the trailing edge, a topside, and an underside,
wherein the nacelle is adapted to be attached to the topside, the leading edge, and the underside of the aircraft wing, and
wherein the nacelle has a flat sidewall, a top surface, and a fillet edge between said flat sidewall and said top surface,
wherein the flat sidewall is substantially perpendicular to the topside of the aircraft wing when the nacelle is attached to the aircraft wing,
wherein the fillet edge has a first local radius of curvature (r1) above the aircraft wing and a second local radius of curvature (r2) forward of the leading edge, where the first local radius of curvature and the second local radius of curvature are considered at the intersection point between the fillet edge and the flat sidewall, and
wherein the second local radius of curvature is larger than the first local radius of curvature.

15. A computer program product comprising computer program code to perform, when executed on a computer, the steps of:
receiving data related to an aircraft wing comprising a leading edge, a trailing edge, a chord from the leading edge to the trailing edge, a topside, and an underside;
determining the shape and dimensions of a nacelle to be attached to the topside, the leading edge, and the underside of the aircraft wing at least partly based on the received data, such that
the nacelle has a flat sidewall, a top surface, and a fillet edge between said flat sidewall and said top surface,
the flat sidewall is substantially perpendicular to the topside of the aircraft wing,
the fillet edge has a first local radius of curvature (r1) above the aircraft wing and a second local radius of curvature (r2) forward of the leading edge, where the first local radius of curvature and the second local radius of curvature are considered at the intersection point between the fillet edge and the flat sidewall, and
the second local radius of curvature is larger than the first local radius of curvature; and
outputting the determined shape and dimensions of the nacelle in at least one data record.
